(19) United States
(12) Patent Application Publication
(10) Pub. No.: US 2003/0055757 A1
(43) Pub. Date: Mar. 20, 2003

(54) Method, system and apparatus for enterprise customer contact management

(76) Inventors: Kimberly Ann Pfiffner, Urbandale, IA (US); Kelm Brueschke, Clive, IA (US); Stacey Allen Frett, Grimes, IA (US); Elizabeth Juel Hamer, Colfax, IA (US); Andrew Thomas Kreider, Norwalk, IA (US); Douglas John Rants, Grimes, IA (US); Matthew Weinecke, West Des Moines, IA (US); Shelley Lynne Winchel, West Des Moines, IA (US); Kurt David Zimmermann, Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 09/918,091

(22) Filed: Jul. 30, 2001

(51) Int. Cl. G06F 17/00; G06F 17/60

(52) U.S. Cl. 705/35; 707/104.1

(57) ABSTRACT

The present invention discloses a scalable system for enterprise wide client interaction management across a plurality of business units. One aspect of the invention includes an enterprise wide database containing shared client interaction information and client interaction information specific to at least one of the business units, a contact center application capable of accessing the database and causing client interaction information to be displayed, and a support application capable of accessing the database, creating default and configuration for each business unit, and create information restrictions for each business unit. Another aspect of the invention includes restricting the ability to access a first customer information field based on a second customer information field.

### BACKGROUND OF THE INVENTION

1. Field of the Invention

The present invention relates to enterprise wide contact management. The enterprise includes a plurality of business units that may involve financial services, insurance services, retirement planning, and other businesses. More particularly, though not exclusively, the present invention relates to a system that tracks customer interaction, packages, customer responses to marketing campaign material, customer account information, package fulfillment, and other information. In addition, the present invention provides for the use of restrictions associated with a customer field, a service representative field, or other particularized information.

2. Problems in the Art

Businesses today face a number of challenges in managing productivity and efficiency, particularly where a business includes a number of business units. A business unit is simply refers to a unit, division, subsidiary, department, affiliate or other group that deals in certain business products or services and that may have a relationship with another business unit. Business units may be involved in businesses such as, without limitation, financial services, insurance services, retirement planning, and other businesses.

Expanding businesses by adding business units or increasing the geographic region serviced by the business is desirable, as it provides the opportunity to introduce savings through application of economies of scale. At the same time, however, numerous complexities in the operation of the business are added. These complexities must be understood and eliminated in order to maximize or otherwise increase business, operating efficiencies. These problems are particularly troublesome in the financial service area, insurance area, retirement planning area, and related businesses.

One problem for businesses operating with multiple business units is that customers or clients may receive multiple packages from different business units in a day. Shipping fees or postage must be paid on each of these packages or shipments. The cost of shipping multiple packages is more than the cost of shipping one package with all the necessary material.

Another problem relates to cross-selling and promotional campaigns. When there are multiple business units, the business can use relationships developed between one business unit and a client or customer in order to leverage business for its other business units. This is particularly true when the business units provide related services. For example, when information is sent from one business unit to a customer or client, promotional information concerning services provided by a second business unit may be enclosed in a package and provided to the customer or client. It is difficult, however, to track the relationship between services that a customer or a client is using, as well as promotional campaigns that are targeted at the customer or client. There is a need to determine which promotional campaign generated the customer's or client's interest so that better, more appropriately targeted, cost-effective promotional campaigns and cross-selling can be achieved.

In addition, the identification of a promotional campaign or product cross-selling should be done in an unobtrusive and efficient manner. For example, having a service representative asking the caller for information concerning the promotional campaign that drew the customer's interest may inconvenience the customer, may be seen by the customer as an invasive inquiry, and may otherwise have a negative effect, perhaps damaging rapport with the customer.

Yet another problem involves the establishment and enforcement of rules governing client or customer contacts and interactions. This is particularly true concerning financial and insurance information. Often times this information may be considered private or confidential. A client or customer may, for example, allow some of the information to be provided, altered or amended by a spouse. But the client or customer may want other information kept private from the spouse. Thus, a client counselor must be aware of all of these restrictions on the customer information, which impacts upon the counselor's ability to do business with a particular person.

Another problem relating to financial services and insurance services is that different states have different requirements regarding the sale of the services and the licensing of those who may sell the services. This introduces a number of complexities for those businesses who attempt to serve a large geographical area with multiple political subdivisions having their own rules, standards, laws, and requirements on brokers, dealers, agents, and others. For example, a broker/dealer servicing a large geographical area may be licensed in some states but not others for certain transactions. At the same time, there may be transactions that the broker/dealer may perform in all states. Thus the broker/dealer must avoid certain sales or transactions in states where licensing requirements are not met or where he or she is otherwise restricted from making sales or transactions. Accordingly, the broker/dealer must check the residence of the customer, the nature of the transaction involved, and his or her current licenses and ability to perform transactions within that jurisdiction. This process takes time and it is prone to error, especially where a broker, dealer, or agent is servicing multiple jurisdictions including nationwide or international service. One current method of tracking licensing requirements involves the placement of multiple notes on or near a broker/dealer's computer display.

A need therefore exists in the art for an efficient and cost effective means to provide enterprise wide customer interaction management to meet the needs of the business having multiple business units.

### FEATURES OF THE INVENTION

A general feature of the present invention is the provision of a system and methods which overcome the problems and deficiencies found in the prior art.

A further feature of the present invention is the provision of the system that reduces shipping and handling costs involved with shipping multiple packages from associated business units.

A further feature of the present invention is a system and method to prevent brokers, dealers, or agents servicing a large geographical region to make sales or engage in transactions for which they are not licensed.

Another feature of the present invention is a system and method of providing promotional campaign tracking.

A further feature of the present invention is providing promotional campaign and cross-selling information in a manner that is neither inconvenient nor disruptive to a customer or client.

A further feature of the present invention is to restrict customer service representatives from sharing confidential information with a caller having a relationship to the client or customer.

A further feature of the present invention is to restrict a customer service representative from permitting a person with a relationship to a particular customer account to transact business concerning that account without proper authorization.

Yet another feature of the present invention is to reduce the time and/or effort required by a customer to fill-in a form.

These as well as other features and advantages of the present invention will become apparent from the following additional disclosure.

### SUMMARY

The present invention relates to a system and method for providing enterprise wide contact management. The system is for use by one or more business units within an enterprise, including financial and insurance business units. In its preferred form, the invention may be used to track customer contacts, packages, customer response to promotional materials, customer account information, package fulfillment, and other information.

One aspect of the invention relates to providing an efficient method of package fulfillment. Information from multiple business units may be combined into a single package that may be mailed, or delivered by facsimile, electronic mail, or other delivery service. This permits a reduced number of deliveries to be made to a customer.

Another aspect of the present invention includes tracking promotional campaigns. The present invention provides for particular promotional campaigns of one business unit to be used to sell products or services of another business unit. By use of telephony and other identification means, the relationship between promotional materials distributed through a particular promotional campaign and the success of the distribution of those materials can be tracked. This is particularly advantageous when there are multiple business units having a relationship whereby promotional campaigns for one business unit are sent to customers of another business unit where it is likely that a customer may be interested in the product or services of the second business unit.

Still another aspect of the invention includes configurable restrictions on access to view, add, or change particular data fields. By way of example only, the restrictions may be based on the states associated with a customer, the licensing requirements of that state, and the licenses held by an operator. Such configurable restrictions provide the advantages of eliminating improper use of customer information and eliminating unauthorized transactions.

Yet another aspect of the present invention is to provide for pre-printed forms to be sent to customers. A contact center representative can elicit from a customer information that is associated with a form that the customer must receive, complete, and return. The information is then used to complete or partially complete the forms that are sent to the customer, so that the customer has reduced effort in filling out the form, perhaps only needing to sign and return the form.

### BRIEF DESCRIPTION OF THE DRAWINGS

FIG. 1 is a block diagram of an enterprise wide database and applications that access the enterprise wide database of the present invention.

FIG. 2 is a diagrammatic representation of a graphical user interface for a call screen application, showing topic tree information enabled and disabled upon an interested party roll.

FIG. 3 is a diagrammatic representation of the graphical user interface of the call screen application, showing campaign information associated with a contact.

FIG. 4 is a diagrammatic representation detailing the campaign information of a current campaign associated with a contact.

FIG. 5 is a diagram of the layered architecture of one embodiment of the invention.

FIG. 6 is a diagram of the client component of one embodiment of the present invention.

FIG. 7 is a diagram of the application server component of one embodiment of the present invention.

FIG. 8 is a network topology of one embodiment of the present invention.

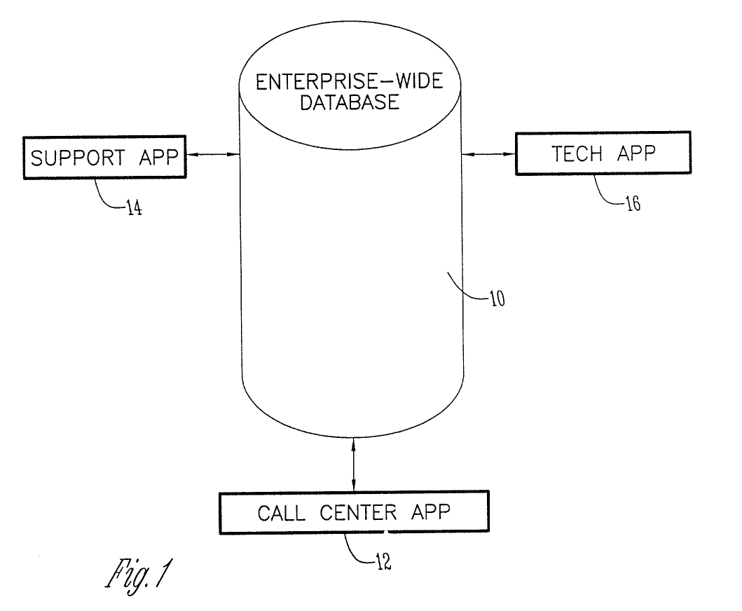

### DETAILED DESCRIPTION OF THE INVENTION

The present invention will now be described as it applies to a preferred embodiment. It is not intended that the present invention be limited to the described embodiment. It is intended that the invention covers all modifications and alternatives which may be included within the spirit and broad scope of the invention.

The preferred embodiment is directed to a system and method for enterprise wide customer interaction. Those skilled in the art will recognize that the system and methods disclosed as a part of the preferred embodiment can be easily adapted for other business units and related contact information.

The preferred embodiment uses a system that includes an enterprise wide database 10, a contact center application 12, a support application 14, and a tech application 16. The enterprise wide database 10 contains information concerning each customer, customer accounts, and customer contacts. The database is accessible by the contact center application 12, the support application 14 and the tech application 16. The database itself may be of any number of formats and use any type of data connectivity. For example, the database can be DB2 available from IBM running under the OS/390 operating system. When the database is running on a legacy system, the present invention contemplates that DB2 Connect, available from IBM, may be used to access the database. The present invention is in no way limited by the type of database format, the type of database connectivity, or the type of server used. The present invention also contemplates that the database can be a relational database or an object database.

The present invention contemplates that the database may be located on a server. The server may be a network server, including a server that is accessible over an intranet or the Internet.

The applications may be written in JAVA, Powerbuilder, or other type of programming language or software such as may be convenient, expedient, or otherwise desirable. The applications may be run locally on a client or may be run on a server. The present invention contemplates numerous embodiments including the use of applets, servlets, and the use of an application server. The present invention is in no way limited by the type of language or application used to construct the applications that interface with the database.

The contact center application 12 is used by a counselor, customer representative, broker/dealer, agent, or other personnel. The contact center application permits such person to enter information concerning a client interaction.

The support application 14 permits each business unit to customize the contact center application. This can include setting default entry screens, restrictions (as will be discussed in greater detail), and other defaults.

The term “business unit” is not used in a narrow sense, but is used in a broad sense to encompass business and units of businesses. A “business unit” may include a unit, division, subsidiary, department, affiliate, business, or any portion of a business.

The tech application 16 may be used for fulfillment purposes. For example, tech application 16 can be used to receive information from database 10, regarding which forms are to be sent to which customer, and then preprint those forms with the known customer information, print mailing labels, or provide other functions such as may be useful or desirable, for fulfillment purposes.

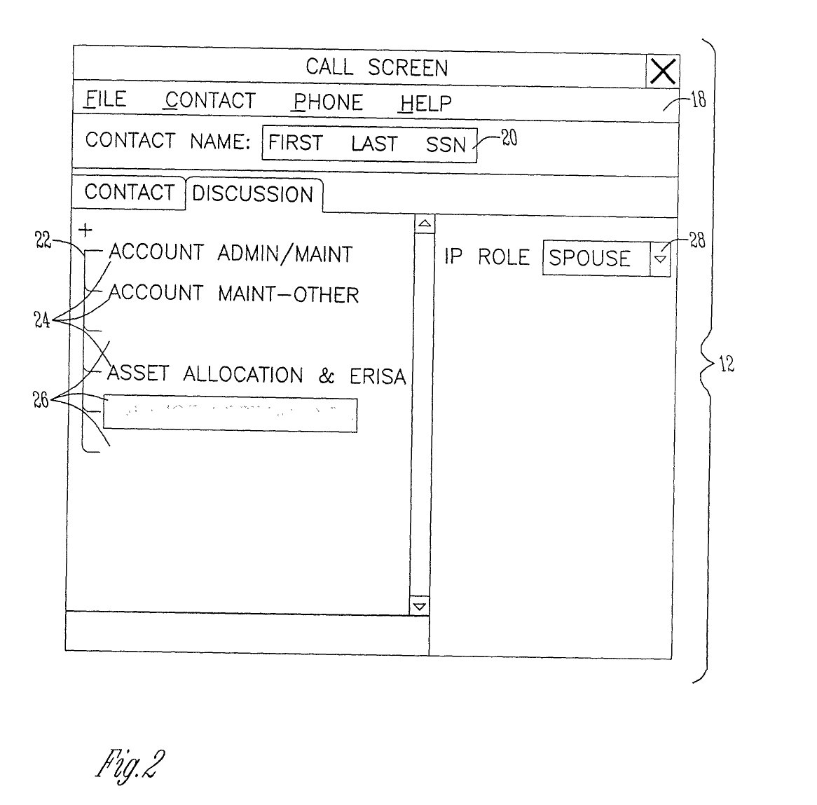

FIG. 2 shows one embodiment of the contact center application graphical user interface. The interface may include a menu 18 and provide information concerning a contact 20, such as the contact's first name, last name, and/or social security number. The contact center application includes a topic tree 22. The topic tree provides a tree or outline of various topics concerning a customer or client. Each topic relates to a set of data fields. Items within the topic tree may be enabled 24 or disabled 26. When items within the topic tree are enabled 24, the enabled topics and the associated data fields may be viewed, altered, or otherwise manipulated by the counselor, service representative, broker/dealer, or agent. Whether or not a particular topic is enabled or disabled is dependent upon restrictions placed on a particular account or for a particular contact, or restrictions related to other data concerning a contact, an account, or the contact center representative.

One data field may be the role of the interested party 28. For example, the interested party may be a spouse. A spouse may be permitted to call and receive information contained within a particular data field and may also be permitted to change data within a particular data field. However, there may be some information that a spouse may not be able to change due to the applicable laws, the terms of an agreement, or the client's instructions. Thus, once the interested party role 28 is set to spouse, certain topics within topic tree 22 may become disabled 26 while other topics may remain enabled 24. When a topic is disabled 26, the data fields associated with that topic are not viewable. Thus, the contact center representative can not erroneously share the information with a caller or modify information that there is not requisite permission to modify.

The present invention contemplates numerous restrictions that can be provided to the database 10 through the support application 14, causing the topic tree 22 to become enabled 24 or disabled 26. These restrictions may be created and applied to comply with a customer's wishes, to comply with the terms of a written agreement between the customer and a business unit or to comply with law. These restrictions may be related to information received from a customer, information received from a telephony system integrated with the database or information related to a particular customer service representative, counselor, broker/dealer, or agent. The present invention permits different business units to create their own restrictions as may be required for all of the previously given reasons. For example, the restriction may be based upon the interested party as previously explained. The restriction may be based upon the resident state of the party and the licensing restrictions of that state of residence. The restrictions may be limited on the basis of whether the party is married or single. The restrictions may also be based upon the primary language spoken by the party, such as English or Spanish.

The topic tree then displays information according to the restrictions. This permits a restricted topic to be disabled so the restricted data fields are not shown and can not be changed. This structure ensures that client counselors can not perform transactions they are not permitted by law to perform or to disclose information they are not permitted to disclose to a particular party. The topic tree structure further ensures that other errors are not introduced, such as sending the wrong forms to a client, or committing errors attributable to use of the wrong data entry screen or field. The use of the topic tree further reduces the amount of information that is displayed, making it easier for a client counselor to find a desired field or screen. Thus the topic tree provides advantages over noncomputer based restrictions, in that the restrictions are enforced by design and there is complete assurance that the restrictions have been properly made.

The topic tree also provides additional business functionality. The topic tree drives what fulfillment is ordered. Based upon the topics selected and the information associated with the selected topic, the selection of the type of fulfillment to order is pre-determined or substantially pre-determined for the client counselor. The fulfillment can, for example, be a particular form or set of forms appropriate to a particular customer and the customer's particular needs. Using the topic tree approach, the correct fulfillment is sent to the customer, as the system reduces or eliminates the need for the client counselor to make decisions regarding what type of fulfillment should be sent to the customer.

The topic tree may be implemented as a JTREE component. The present invention is not limited to a specific implementation of the topic tree. The present invention contemplates that the topic tree may also be implemented as a JAVA component, JAVA control, an ACTIVEX control, or other implementation such as a particular language or development platform may permit.

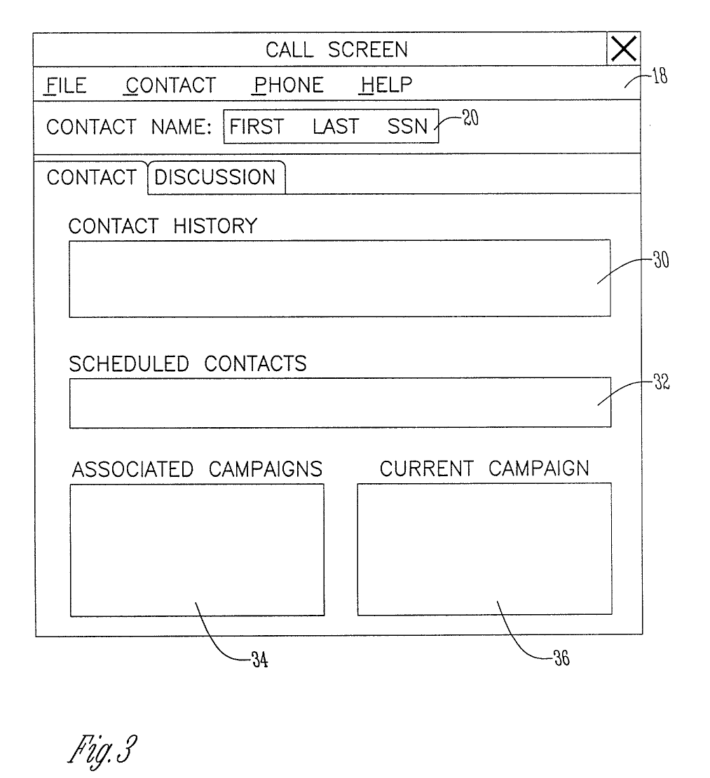

FIG. 3 is a diagrammatic representation of the screen display of the contact center application. The graphical user interface includes a menu 18 and contact identifying information 20. The contact identifying information may include, without limitation, a first name, a last name, and a social security number associated with a particular person.

The graphical user interface also includes contact history information 30. The contact history information includes information such as, but not limited to, the date and time of previous contacts or customer interactions. The contact history information may include the type of contact made whether it be an incoming phone call, an outgoing phone call, an incoming e-mail, an outgoing e-mail, the transmission of a fax, the receipt of a fax, the transmission of a mail package, or the receipt of a mail package. The contact information may also include the particular contact center that made the contact, the counselor who initiated or responded to the contact and other information associated with the contact such as may be useful or desirable in a particular application.

The scheduled contacts information 32 includes such information as the date and time of scheduled contacts, the information to be exchanged during the contact, the counselor who will make the scheduled contact, the type of method used to make the contact, the contact center or business unit making the contact, the number of attempts to be made in making the contact, and other comments, descriptions, or other information such as may be useful or desirable.

The screen display associated with a contact center application may also include associated campaign information 34. The associated campaign information may include such information as to whether discussion took place concerning campaign information, the type of campaign that is associated with the client contact or interaction, the effective date that the associated campaign began and the ending date of the campaign. In addition, the campaign information may include such information as may otherwise be useful or desirable.

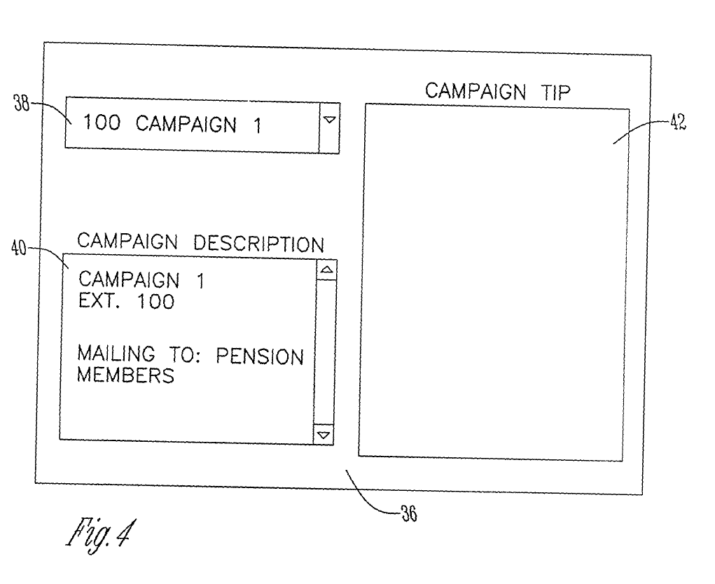

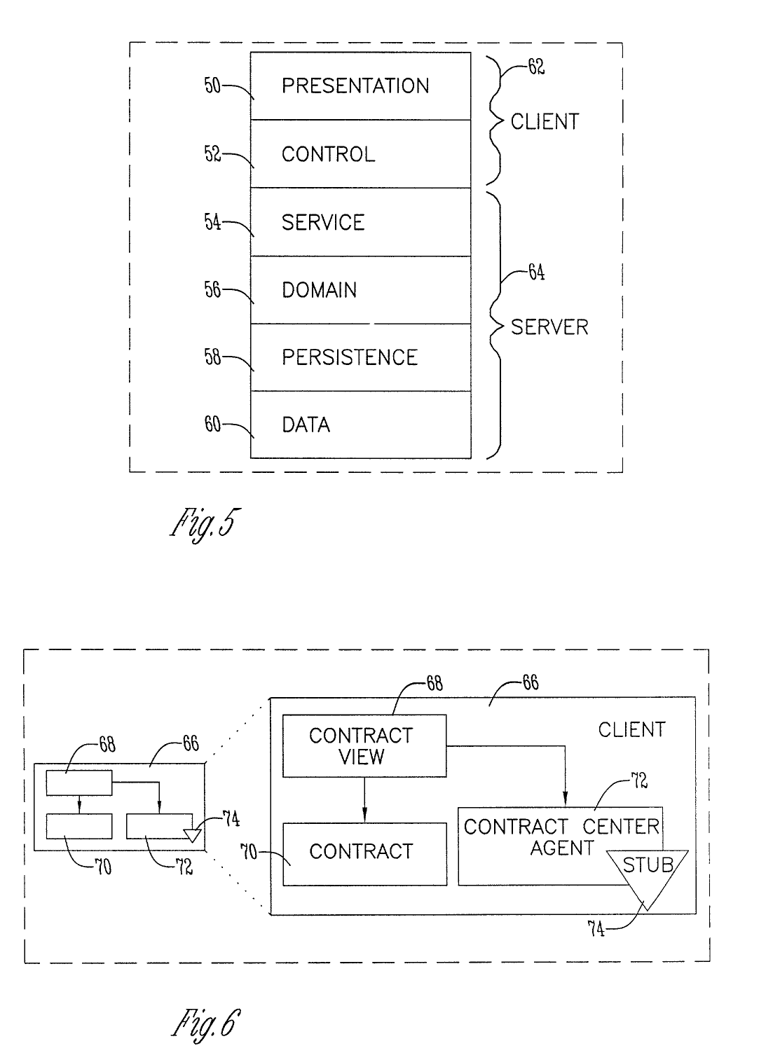

The call screen application may also include current campaign information 36. Current campaign information 36 is best shown in FIG. 4. The current campaign information may include the name of a campaign and the associated extension number 38. This information may be selected from a drop-down list box or manually input or selected from a list or otherwise displayed. The present invention contemplates that campaign information may be identified by just the extension number, a description, or other campaign identifier. The current campaign includes a campaign description 40. The campaign description provides more detailed information concerning the name of the campaign, the extension number associated with the campaign, the distribution of the campaign to who and when, and other information. In addition, the current campaign information may include a campaign tip 42. The campaign tip may contain information such as useful selling information that is associated with the campaign and/or products or services that are cross-sold.

The campaign information may be associated with a particular phone extension or number. Thus, when a customer calls a number or an extension, a telephony system can be used to record the incoming call was made to a particular extension number and therefore is associated with a particular campaign. This information is then available to the contact center counselor when they answer the call. Thus, at the time of answering the call, the contact center counselor is aware of the campaign information that lead to the call. This allows the contact center counselor to better service the client and to establish better rapport. This information also may be stored in the database. Then the success of a particular campaign can be determined by examining the number of calls and subsequent actions which arose from a particular campaign. The present invention contemplates that the telephony aspect of the invention may be developed using the JAVA telephony application programming interface (JTAPI). The present invention contemplates that other telephony components could be used as the type of software used, operating system used, and other factors may require or suggest.

The present invention also contemplates that contact may be made through other forms of communication such as through electronic mail or through hypertext links. Particularized e-mail addresses or identifiers may be used in these situations so that the campaign information can also be tracked.

The package of the present invention need not be a physical package such as is mailed or delivered. The package may be an electronic message. For example, the present invention contemplates that a single customer may do business with multiple business units. The present invention permits multiple e-mail messages to be combined into a single message to be sent to the customer. This provides a more convenient method for sending information to a customer in that the customer will be able to see all the information in a single message. In addition, advertising or other information associated with various campaigns may be included within the single mail message.

The database is stored on a server that is accessible over a network from other computers or some networks. For example, the database may reside on a web server, the database may be a DB2 format and the server software may be IBM WebSphere.

Although it should be apparent to one skilled in the art that the present invention may be implemented in numerous ways, one such example is now shown. In the example of the present invention, existing data bases on the main frame systems are leveraged.

In this example, the system of the present invention complies with an Enterprise Wide Technical Architecture (EWTA). The EWTA provides a framework for an entity's deployment of technology. To comply with the EWTA, the system of the present invention has a layered architecture. The presentation layer 50 is used to manage user interaction with the system. This layer can be implemented through a JAVA GUI, a web client, or other application.

The next layer is the control layer 52. The control layer 52 is used to maintain conversational state for the client and to invoke services as required. The control layer includes application processing that may need to be performed.

The domain layer 56 includes the use of domain objects, the domain objects transported to the client. The domain objects may also be cached on the server in order to improve performance.

The service layer 54 includes distinct services which are mix and match capable. Examples of such services include an IP service, a contact service, a fulfillment service, a sales service, and a quick close service.

The persistence layer 58 provides a persistence mechanism for each service. Persistence mechanisms may be layered on top of CICS agents (CICS) or TopLink for relational data access.

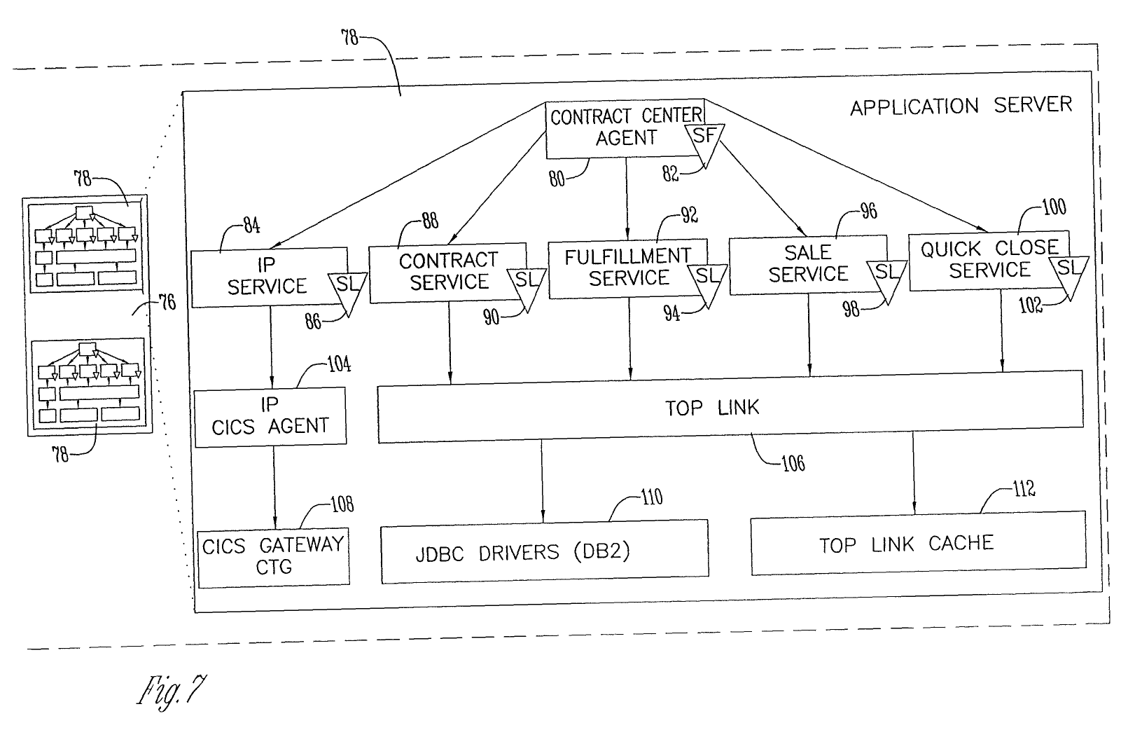

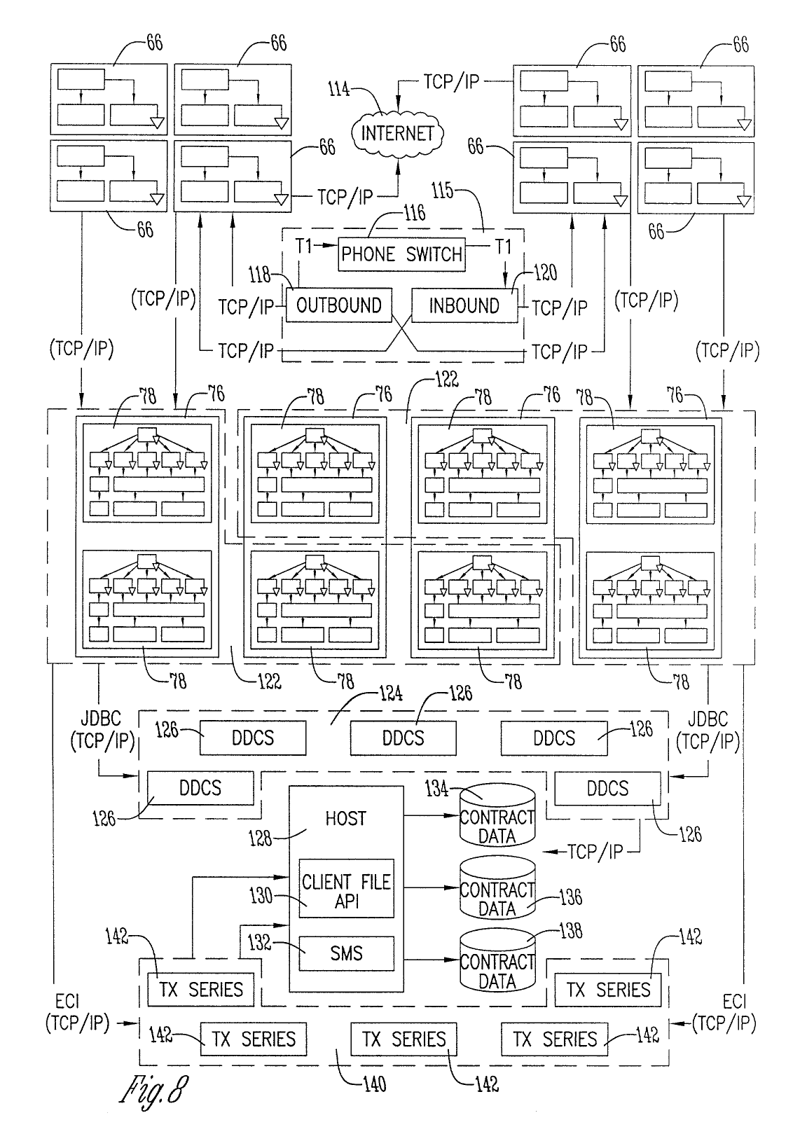

The data layer includes CTG and JDBC such as may be used to access CICS data and DB2 data, respectively. FIG. 6 shows a client topographic component. In FIG. 6, a client 66 is shown. The client 66 includes a contact view 68, a contact 70, a contact center agent 72 and a stub 74 associated with the contact center agent 72. The client may use a JAVA run time environment of (JRE). These interface with the client may be delivered through use of JAVA Swing components. This can include the use of Enterprise JAVA Beans (EJB) which are a service side component architecture for the development and appointment of distributed object systems and JAVA. The instrument configuration of the client to be specific to a particular contact center for a business unit. Each contact center may have its own agent and custom views in order to configure the client application to a particular use.

An application node 76 is shown. The application node 76 can be a physical machine. On the physical machine of the node 76, multiple application servers 78 can exist. Each application server 78 represents a JAVA Virtual Machine (JVM). A single node 76 can host many application servers. The node can run under a Microsoft Windows NT server operating system and may utilize an IBM Web Sphere application server. The application services are delivered through Enterprise JAVA Beans. Configuration includes each JEB tooling, middleware, and configuration specific to each business unit contact center.

Each application server 78 has a number of components. These components include a contact center agent 80. The contact center agent 80 may have an associated EJB stateful session bean 82. The stateful session bean 82 is an extension of the client application. It performs tasks on behalf of the client and maintains state related to that client.

In addition, application server 78 includes a number of application services delivered through EJB's. These services include an IP service 84 with an associated stateless session bean 86. The stateless session bean 86 is a collection of related services each represented by a method. The bean maintains no state from method invocation to the next. The allocation service 78 also includes a contact service 88 with associated stateless session bean 90, a fulfillment service 92 associated with a stateless session bean 94, a sales service 96 associated with a stateless session bean 98, and a quick close service 100 associated with a stateless session bean one of two.

In addition to these services, the application server 78 has an IP CICS agent 104 and a CICS Gateway CTG 108. These CICS components are used to communicate with a database running on a CICS operating environment, and are examples of the middleware contemplated by the present invention.

The application server also includes a TopLink component 106. The TopLink component 106 maps relational database tables to objects. The application server 78 also includes JDBC drivers 110 to connect with a DB2 database. The application server 78 includes a TopLink cache 112 as well.

FIG. 8 shows the topology of the system of the present invention. A number of clients 66 are shown. These clients are connected to the Internet 114. In addition, these clients are connected to a telephony system 115. The telephony can include a phone switch 116, such as a Lucent G3R. The phone switch 116 must be connected to a Lucent server 120 to accept inbound calls. The Lucent server 120 provides telephony integration for managing the inbound calls. The telephony system 115 may also include an outbound server 118. The outbound server may be a Melita server that has predictive dialer management capabilities. The outbound server is used to manage outbound calls and for call blending. The clients are also connected through TCP/IP one or more server sets 122 containing application servers 78 that may be run on multiple nodes 76. These nodes communicate either through JDBC with distributed data base connections services (DBCS) which acts as a gateway to the DB2 database, or alternatively, the Electronic Call Interface (ECI) can be used to connect with a gateway to the CICS. This can be through IBM's TX series product. This permits data such as contact data 134, client file data 136, and agent data 138 in a database associated with a host 128 to be accessed.

The system of the present invention described is in no way limiting. In particular, one skilled in the art can appreciate that there are numerous variations that could be made in the implementation of the invention. In particular, different architectures could be used, including those architectures which incorporate main frame computers and those which do not. In addition, numerous types of computers, operating systems, database products, middleware products, and related components may be used. The present invention contemplates these and other variations.

A general description of the present invention as well as a preferred embodiment has been set forth above. Those skilled in the art will recognize and will be able to practice additional variations of the methods and devices described which fall within the teachings of this invention. Accordingly, all such modifications and additions are deemed to be within the scope of the invention which is to be limited only by the claims appended hereto.

What is claimed is:

1. A first ever scaleable system for enterprise wide client interaction management across a plurality of business units comprising:
an enterprise wide database, the database containing shared client interaction information and client interaction information specific to at least one of the business units;
a contact center application capable of accessing the database and causing client interaction information to be displayed; and
a support application capable of accessing the database, creating default configuration for each business unit, and creating information restrictions for each business unit.

2. The scalable system for enterprise wide client interaction management of claim 1 wherein one or more of the business units is selected from the set comprising an insurance unit, a financial unit, a retirement planning unit, a distribution unit, a mortgage unit, a pension unit, and a banking unit.

3. The scalable system for enterprise wide client interaction management of claim 1 wherein the contact center application is written in JAVA.

4. The scalable system for enterprise wide client interaction management of claim 1 wherein the contact center application is written in POWERBUILDER.

5. The scalable system for enterprise wide client interaction management of claim 1 wherein the support application is written in JAVA.

6. The scalable system for enterprise wide client interaction management of claim 1 wherein the support application is written in POWERBUILDER.

7. A new method of restriction based customer interaction management between a customer and a customer representative comprising:
initializing a customer interaction;
retrieving information related to the customer; and
restricting the representative's ability to access a first customer information field based on a second customer information field.

8. The method of restriction based customer interaction management of claim 7 wherein the second customer information field contains a state.

9. The method of restriction based customer interaction management of claim 7 wherein the second customer information field contains a marital status.

10. The method of restriction based customer interaction management of claim 7 wherein the second customer information field contains a language.

11. The method of restriction based customer interaction management of claim 7 wherein the step of initializing a customer interaction is selected from the set comprising receiving a phone call from a customer, calling a customer, receiving a facsimile from a customer, sending a facsimile to a customer, receiving an electronic message from a customer, sending an electronic message to a customer and visiting personally with a customer.

12. A method of restricting unauthorized transactions by persons unlicensed to make transactions within a particular political subdivision to customers within the political subdivision using a computer system comprising:
receiving information concerning the customer's political subdivision;
receiving information concerning the broker/dealer's licensing for the customer's political subdivision;
selectively enabling data fields based on the customer's political subdivision and the broker/dealer's licensing.

13. A first ever system for enterprise wide client interaction management across a plurality of business units comprising:
a computing device including a digital storage medium and a central processing unit;
an enterprise wide database, the data base containing shared client interaction information and client interaction information specific to at least one of the business units;
a contact center software application in the digital storage medium and executed by the computing device for accessing the database and causing client interaction information to be displayed; and
a support software application in the digital storage medium and executed by the computing device for accessing the database, creating default configurations for each business unit, and creating information restrictions for each business unit.

14. The system for enterprise wide client interaction management of claim 13 wherein the business units includes one or more of the business units selected from the set comprising an insurance unit, a financial unit, a retirement planning unit, a banking unit, a pension planning unit, and a mortgage unit.

15. The contact center software application of claim 13 wherein the contact center software application is a JAVA application.

16. The system for enterprise wide client interaction management of claim 13 wherein the support software application is a JAVA application.

17. A software article for use in interacting between a contact center and a customer, the software article comprising:
a computer readable signal bearing medium;
means in the medium for executing software for interacting between the contact center personnel and the client;
means in the medium for creating a user interface for the software, the user interface having objects that comprise a tree structure for displaying account information in hierarchical form; and
means in the medium for creating a user interface for the software the user interface having the capability of enabling and disabling information topics within the hierarchical form; and
means in the medium for allowing a user to navigate the tree structure in the user interface to display information related to an enabled topic.
